(19) United States
(12) Patent Application Publication
(10) Pub. No.: US 2013/0047866 A1
(43) Pub. Date: Feb. 28, 2013

(54) Mobile Solid Waste Material Collection and Handling Device and Method of Use

(71) Applicants: Bradley Rex Grady, Covington, TX (US); Michael Dean Keathley, Sayre, PA (US); Michael Ray Pence, Carrollton, OH (US)

(72) Inventors: Bradley Rex Grady, Covington, TX (US); Michael Dean Keathley, Sayre, PA (US); Michael Ray Pence, Carrollton, OH (US)

(73) Assignee: Grady Rentals LLC, Cleburne, TX (US)

(21) Appl. No.: 13/601,667

(22) Filed: Aug. 31, 2012

Related U.S. Application Data
(60) Provisional application No. 61/529,689, filed on Aug. 31, 2011.

(51) Int. Cl. B30B 9/30; B30B 13/00; B65B 13/02; B30B 15/30; B30B 15/34

(52) U.S. Cl. 100/3; 100/100; 100/35; 100/37

(57) ABSTRACT

A mobile unit for compacting and baling waste, including a transport vehicle, and a waste collection and handling assembly attached to the transport vehicle. The waste collection and handling assembly has a loader, a hopper, and a compactor. The loader is configured to pick up and carry the waste, the hopper receives the waste from the loader, and the compactor is attached to the hopper, is configured to receive waste from the hopper, and to compact the waste into bales.

### CROSS-REFERENCE TO RELATED APPLICATION

This application claims the benefit of priority from U.S. Provisional Patent Appln. No. 61/529,689, filed Aug. 31, 2011, the disclosure of which is incorporated herein by reference in its entirety.

### BACKGROUND OF THE INVENTION

1. Field of the Invention

This invention relates in general the field of solid waste material collection and handling. In particular, this technology relates to a mobile solid waste material collection and handling assembly.

2. Brief Description of Related Art

Many worksites, such as, for example, oil rig sites, generate waste. For example, many oil rig sites have plastic drums, barricades, and other products that are periodically scrapped and replaced. In addition, many oil rig sites have fluid retention pits having plastic liners that line the insides of the pit, and prevent fluids within the pit from contacting the soils around the pit. These plastic liners are periodically removed and scrapped, such as to replace aging liners, or when a pit is drained of fluid.

Typically, waste produced at an oil rig site is trucked away from the site to a remote waste disposal or recycling facility. At some rig sites, because of the volume of waste generated, it may be necessary for many trucks to travel to the site to remove the waste. If the number of required trucks is great enough, the truck traffic to and from the site may be problematic. For example, many oil rig sites are accessible only by small roads, which are susceptible to degradation, and may be ruined by heavy truck traffic.

In addition, in instances where a rig owner would like to recycle waste plastic, some oil rig site waste should be compacted/baled before it will be accepted by a recycling facility. For example, many recyclers require baling or compaction of fluid retention pit liners because otherwise they are large and difficult to handle and process.

### SUMMARY OF THE INVENTION

Disclosed herein is a mobile unit for compacting and baling waste. The mobile unit is configured for transport on a vehicle, such as, for example, a truck. In addition, the mobile unit is capable of collecting and handling waste. For example, the mobile unit may include a loader and a compactor with a hopper. The loader is configured to pick up and carry the waste to the hopper. The hopper is attached to the top of the compactor and directs the waste into the compactor. Inside the compactor, the waste is compacted into bales that can be tied and expelled from the compactor. The compact bales of solid waste may then be stored at a worksite until enough bales are accumulated to justify entry of a waste disposal truck to remove the bales.

The mobile unit may also be equipped with additional components. For example, the mobile unit may include a fluid storage tank positioned to capture any liquids that may be contained in the solid waste and that are removed from the solid waste during the compaction process. In addition, the mobile device may include a generator, and/or a power take-off from the vehicle engine, to provide power to the components of the mobile unit, such as the loader and the compactor. Furthermore, the mobile device may include safety features, such as guardrails and wire mesh.

Also disclosed herein is a method of compacting and baling waste using a portable waste compactor. The method includes transporting a waste compactor to a worksite on a vehicle, picking up the waste with a loader, and delivering the waste to the waste compactor using the loader. Thereafter, the waste compactor compacts and bales the waste and expels the bales of waste from the compactor. Because the compactor is attached to a vehicle, it can be easily moved from one worksite to another.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a front perspective view of a mobile solid waste material collection and handling device in accordance with this invention;

FIG. 2A is a partial right side view of the mobile solid waste material collection and handling device of FIG. 1;

FIG. 2B is a partial right side view of the mobile solid waste material collection and handling device of FIG. 1;

FIG. 3A is a partial left side view of the mobile solid waste material collection and handling device of FIG. 1;

FIG. 3B is a partial left side view of the mobile solid waste material collection and handling device of FIG. 1;

FIG. 4 is a rear perspective view of the mobile solid waste material collection and handling device of FIG. 1;

FIG. 5A is a rear perspective view of the mobile solid waste material collection and handling device of FIG. 1, showing a claw in the closed position attached to the loader;

FIG. 5B is a is a rear perspective view of the mobile solid waste material collection and handling device of FIG. 1 showing, a claw in the open position attached to the loader; and

FIG. 6 is a perspective view of a bale produced by a mobile solid waste material collection and handling device of the present technology.

### DETAILED DESCRIPTION OF THE EMBODIMENTS

The present invention now will be described more fully hereinafter with reference to the accompanying drawings in which a preferred embodiment of the invention is shown. This invention may, however, be embodied in many different forms and should not be construed as limited to the embodiment set forth herein. Rather, this embodiment is provided so that this disclosure will be thorough and complete, and will fully convey the scope of the invention to those skilled in the art. Like numbers refer to like elements throughout.

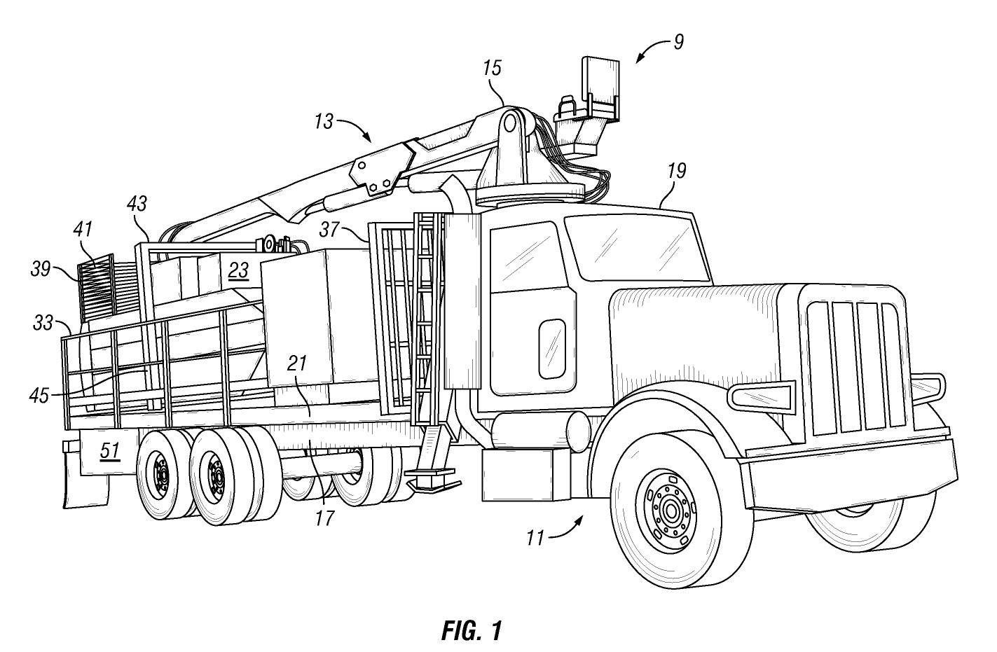

Referring to FIG. 1, in an embodiment, the mobile solid waste material handling and collection device 9 has a transport vehicle 11 with a waste collection and handling assembly 13 mounted thereon. In this embodiment, the transport vehicle 11 may be a truck that may have three or more axles. The truck may be powered by a diesel engine. Alternatively, the truck may be powered by a gasoline, or other type of engine. An A-frame style knuckleboom loader 15 is mounted to the truck frame 17, and may be mounted just behind a cab portion 19 of the vehicle 11. In the embodiment shown, a support frame 21 is mounted to the truck frame 17, behind the cab 19 and optionally behind the knuckleboom loader 15. A compactor/baler 23 may also be mounted to the support frame 21.

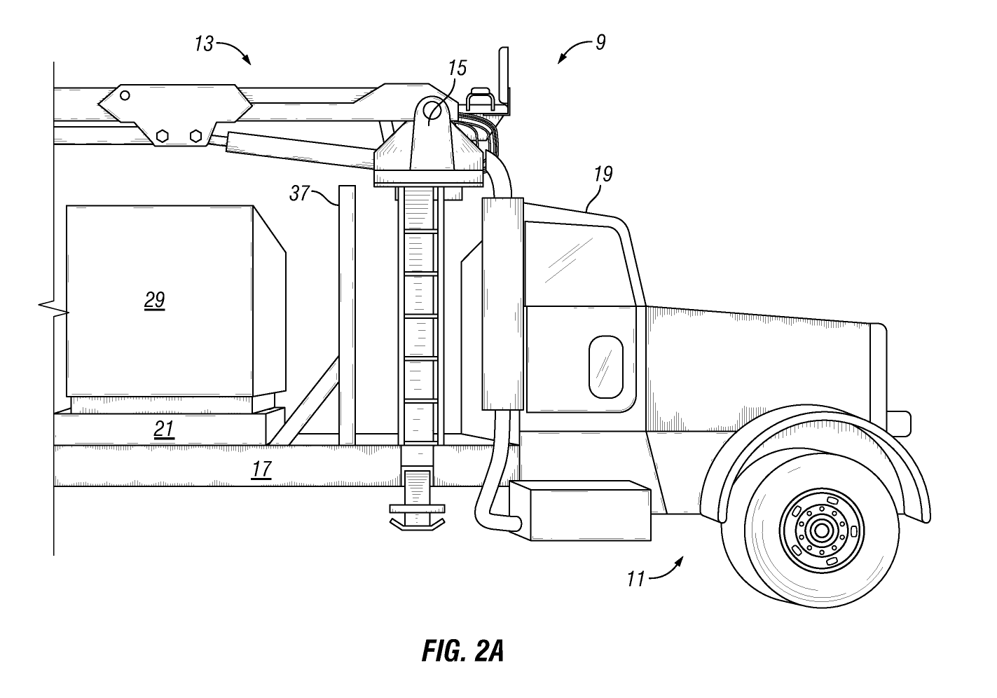

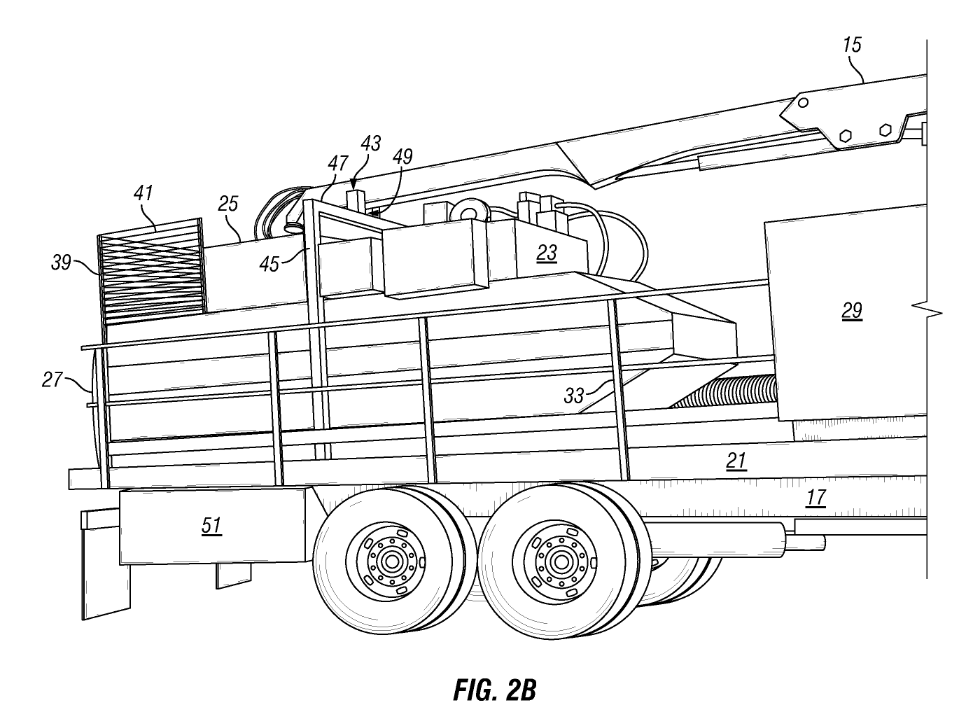

Referring to FIG. 2B, the compactor/baler 23 may have a hopper 25 positioned atop its upper surface that allows solid waste material to be deposited into the hopper 25 for compaction and baling by the compactor/baler 23. Referring to FIGS. 2B, 3B, and 4, a hydraulic bale door 27 is preferably positioned on the end of the compactor/bailer 23, opposite the truck cab 19, and opens to allow the solid waste material to be removed from the compactor/baler 23 once it has been compacted and baled.

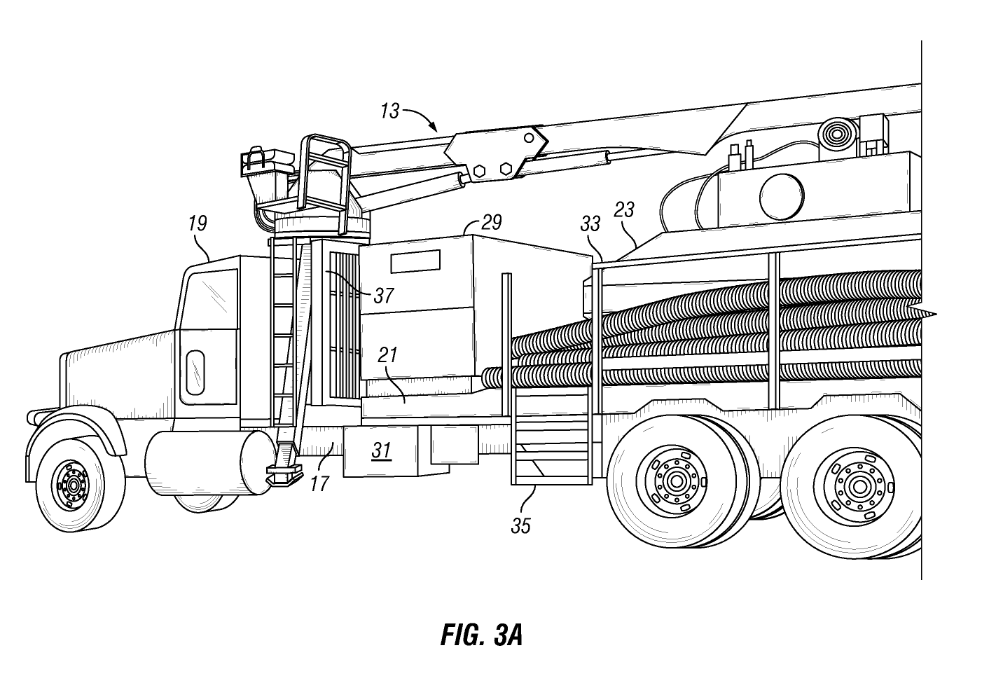

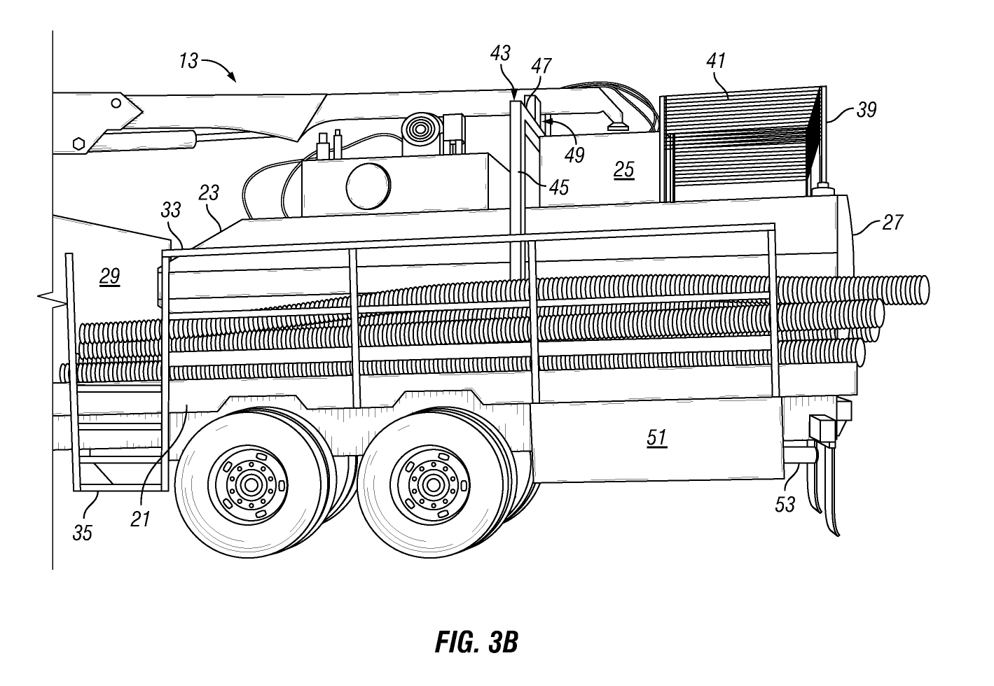

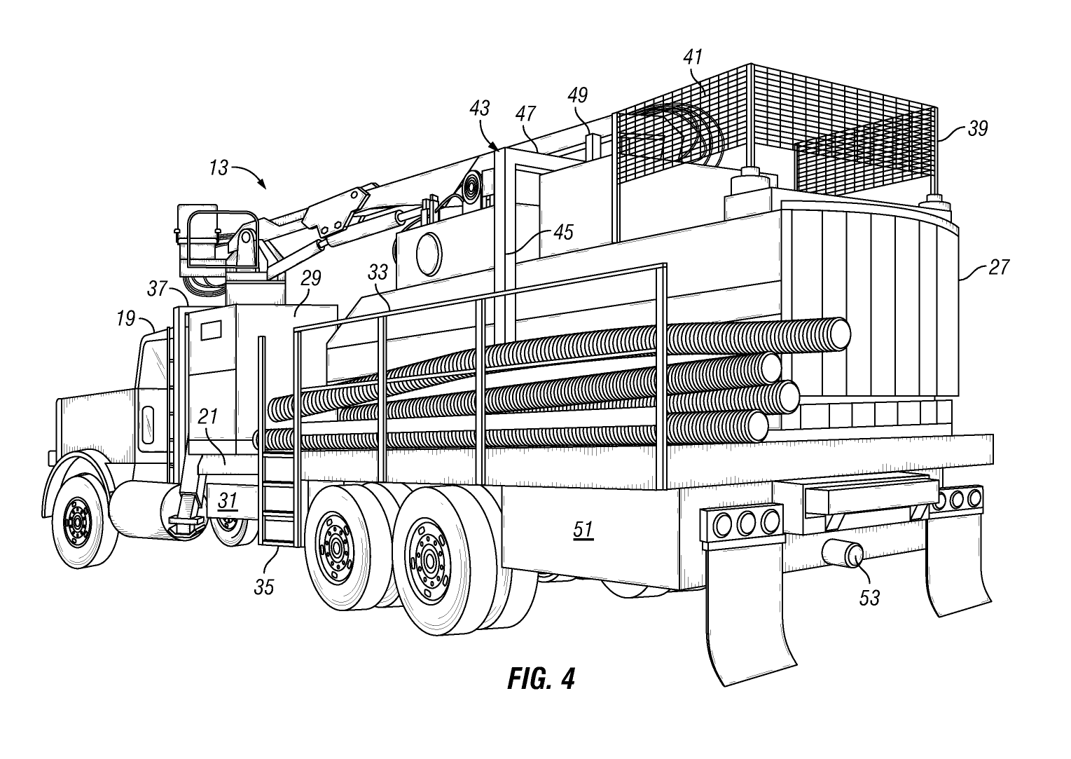

A generator 29 may be mounted to the support frame 21, and, in the embodiment shown, may be positioned between the knuckleboom loader 15 and the compactor/baler 23. In the embodiment shown, the generator 29 is connected to and powers the compactor/baler 23, although it may power other devices as well, such as the loader 15. Also in the embodiment shown, the knuckleboom loader 15 is hydraulically powered via a power take-off (PTO) connected to the engine of the transport vehicle 11. As shown in FIGS. 3A and 4, an auxiliary hydraulic cooler/heat exchanger 31 may be used to control the temperature of the hydraulics of the knuckleboom loader 15. In the embodiment shown in the figures, the auxiliary hydraulic cooler/heat exchanger 31 may be mounted below the support frame 21, and behind the driver side of the truck cab 19.

Referring to FIGS. 2B and 3B, guard rails 33 extend upward from, and extend along the length of, the driver and passenger sides of the support frame 21. On the passenger side of the vehicle 11, the guard rail 33 may extend from the generator to the rear of the support frame 21. On the driver side of the vehicle 11, access steps 35 may be connected to the support frame 21, just in front of the second axle of the vehicle 11. The steps 35 allow for access to the upper surface of the support frame 21. The guard rail 33 on the driver side may extend from the opening for the steps 35 to the rear of the support frame 21.

Referring to FIG. 2A, a headache bar/rack 37 may extend upwards from and along the width of the support frame 21, just in front of the generator 29. The height of the headache bar/rack 37 may be substantially equal to the height of the truck cab 19. In this embodiment, wire mesh (not visible) may be connected to and extend across the upper surface of the support frame 21 to allow the user to move about the perimeter of the compactor/baler 23.

Referring now to FIGS. 2B, 3B, and 4, a guard rail 39 may be connected to, and extend upwards from, the baler/compactor 23, just above the hydraulic bale door 27. Wire mesh 41 optionally extends between the guard rails 39. The guard rail 39 and wire mesh 41 allows a user to stand atop the compactor/bailer 23, and control and monitor a drive ram (not shown) within the compactor/bailer 23, by viewing its activity through the hopper 25. One purpose of the drive ram is to compact the waste within the compactor/baler 23. A knuckleboom support bracket 43 may be connected to the support frame 21. The support bracket 43 consists of two vertical members 45 that extend from opposite sides of the support frame 21. A horizontal member 47 may be connected to and extend between the two vertical members 45, just above the compactor/baler 23. A U-shaped member 49 may be connected to a medial portion of the horizontal member 47, and may be configured to allow the arm of the knuckleboom loader 15 to rest thereon during transport of the vehicle 11.

In certain embodiments, a fluid waste tank 51 may be mounted to the support frame 21, below the compactor/baler 23, and just behind the rear-most axle of the vehicle 11. The fluid waste tank 51 preferably allows any fluid waste produced from compaction of the solid waste materials in the compactor/baler 23 to be collected. The fluid waste tank 51 is advantageous, for example, in oil field applications, where the solid waste may have some fluids containing chemicals or other elements that could potentially be harmful to the environment. Preferably, the fluid waste tank 51 is positioned so that any fluids are collected in the waste tank 51 without coming into contact with the environment. For example, the fluid waste tank 51 may be located directly below the compactor/baler 23 so that fluids drain from the compactor/baler 23 into the fluid waste tank 51 by gravity. In one example embodiment, the fluid waste tank may have a length of about eight feet, a width of about six feet, and a height of about three feet, although other dimensions are possible depending on the configuration of other components of the device 9. Referring to FIGS. 3B and 4, there is shown a valve 53 that may be connected to and extend from the fluid waste tank 51 at the rear of the vehicle 11. The valve 53 allows fluid to be removed from fluid waste tank 51. For example, the valve may allow connection of the fluid waste tank 51 to a vacuum tanker truck that can remove the fluid from the fluid waste tank 51 through a fluid line, or hose (not shown).

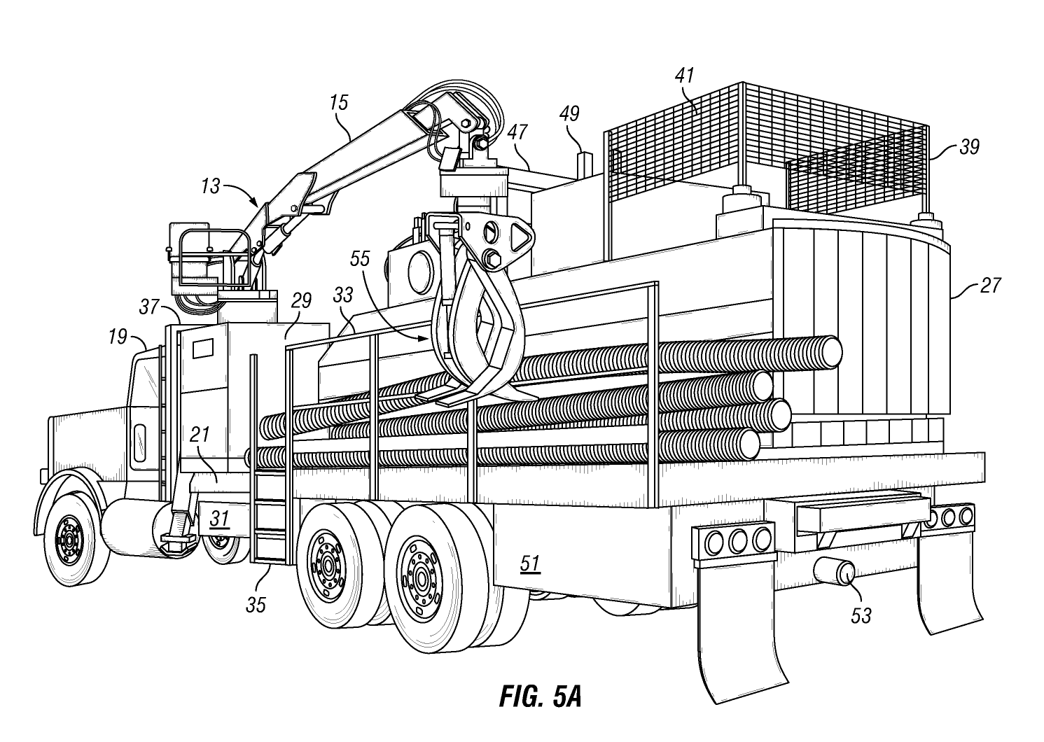

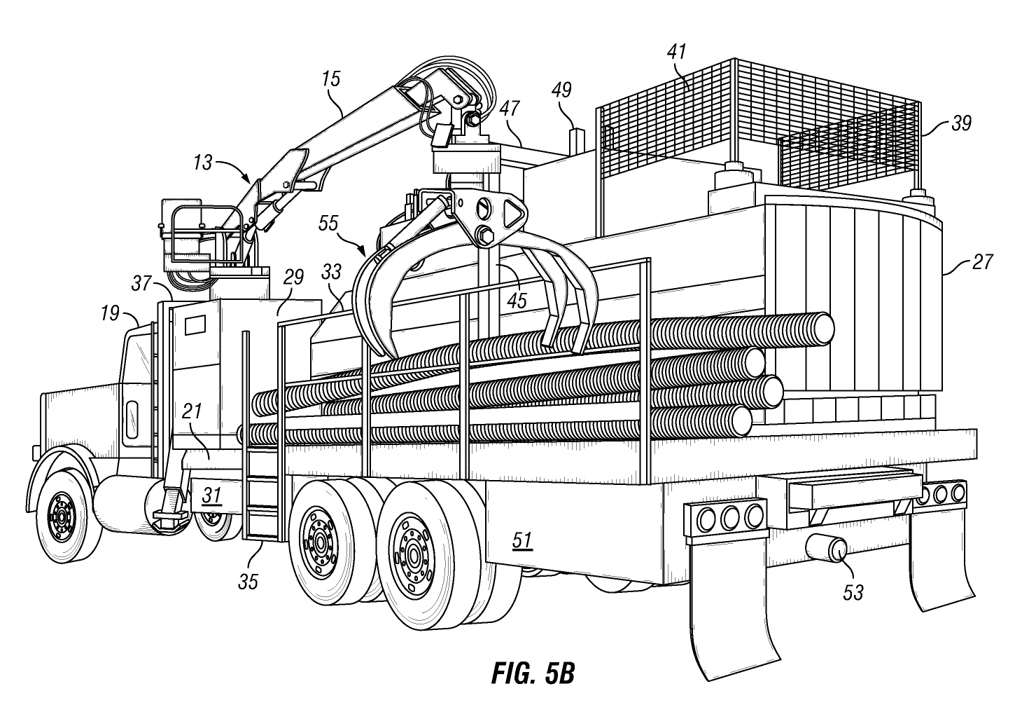

In operation, the mobile solid waste material collection and handling device 9 is transported, i.e., the transport vehicle 11 is driven to a worksite where solid waste material is to be collected. Once the vehicle 11 is transported to a worksite, a user operates the knuckleboom loader 15 to collect solid waste material and to deliver it to the hopper 25 of the compactor/baler 23. To accomplish this, the knuckleboom loader 15 may be equipped with a claw 55, as shown in FIGS. 5A and 5B. The claw is configured to alternate between a closed position (shown in FIG. 5A) and an open position (shown in FIG. 5B). In addition, the claw may be capable of twisting or rotating relative to the knuckleboom loader 15. To collect the solid waste material, the claw 55 opens to the position shown in FIG. 5B. The knuckleboom operator then positions the claw around the waste material to be compacted/baled. Once in position, the claw doses around and grips the waste material. It is then able to pick up the waste material and deliver it to the hopper 25. If the waste material is too large to fit into the hopper 25, the claw 55 may rotate as it pushes the waste into the hopper 25 to help force the waste into the hopper 25. In practice, it may be necessary to prepare the waste material for loading. For example, fluid retention pit liners may be cut into smaller sections prior to loading. In one example embodiment, the liners are cut into about 50 square foot sections.

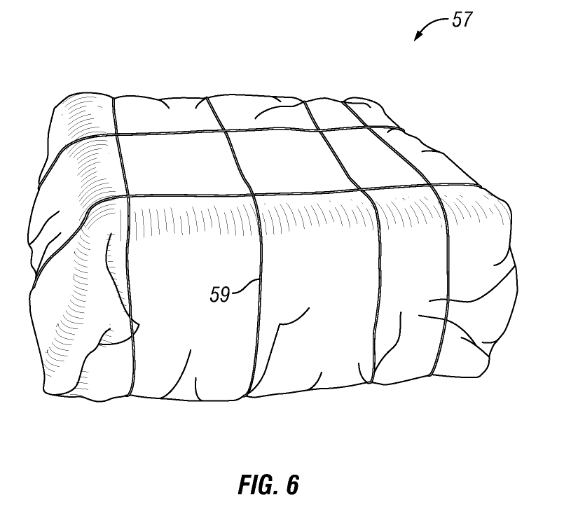

A user, positioned atop the compactor/baler 23 and within the guard rails 39 and wire mesh 41, may monitor the drive ram of the compactor/baler 23 to ensure that it is in retracted position while the hopper 25 is loaded with solid waste materials. Once the hopper 25 is filled with solid waste materials, the user actuates the drive ram within the compactor/baler 23, which expands and compacts the solid waste materials. This process is repeated until the compactor/baler 23 has created a full bale 57 of solid waste materials. A full bale is shown in FIG. 6. As discussed above, fluid waste that may have been present in the solid waste materials compacted in the compactor/baler 23 is collected in the fluid waste tank 51, which may be positioned below the compactor/baler 23.

Once a bale 57 has been created, it may then be tied with wire 59, as shown in FIG. 6. The tying of the bale 57 with wire 59 may be accomplished through an automated process, or may be accomplished by a user. Once the bale 57 is tied, the hydraulic door 27 of the compactor/baler 23 may be opened and the bale of solid waste materials may be unloaded from the compactor/baler 23. In some embodiments, the drive ram (not shown) can be extended to push the bale out from the compactor/baler 23. The bale may be pushed onto another loading/unloading device. For example, a skid-steer loader may be used to unload the bail from the compactor/baler 23. Thereafter the bale 57 may be stored on site, and/or it may be loaded onto another vehicle for transport to a waste disposal/recycling facility. This process is repeated until all solid waste materials have been collected, compacted, and baled.

When desired, such as, for example, when the fluid waste tank 51 is filled, or the vehicle 11 is to be transported to another location, a fluid line (not shown) can be connected to the valve 53 on the fluid waste tank 51 and the fluid waste can be drained from the fluid waste tank 51. For example, a vacuum truck may be connected to the fluid waste tank 51 through the valve 53, and the contents of the fluid waste tank 51 may be transferred from the fluid waste tank 51 to the vacuum truck. Once collection, compacting, and baling of solid waste materials is complete, the knuckleboom loader 15 may be positioned resting upon the support bar 43, with the loader claw 55 positioned within the hopper 25 of the compactor/baler 23. The mobile solid waste material collection and handling device 9 can then be transported to the next work site.

One advantage of the mobile solid waste material handling and collection device 9 disclosed herein, it that it allows for a reduction in truck traffic to and from an oil rig site. This is because a constant stream of waste removal trucks is not required to retrieve uncompacted waste. Rather, as the solid waste is compacted and baled, it becomes fit for storage at the site until enough bales are generated to justify entry of a waste removal truck to remove the bales. Thus, the number of waste removal trucks, and the frequency of their visits, is reduced. This decreased truck traffic helps to preserve roads leading to and from an oil rig site.

In addition, the mobile solid waste material handling and collection device 9 is advantageous because otherwise bulky and voluminous waste, such as fluid retention pit liners, is compacted into a more manageable size. Thus, it is easier for recycling facilities to accept the waste.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification.

What is claimed is:

1. A mobile unit for compacting and baling waste, comprising:
a transport vehicle; and
a waste collection and handling assembly attached to the transport vehicle, the waste collection and handling assembly comprising:
a loader configured to pick up and carry waste;
a hopper that receives waste from the loader; and
a compactor attached to the hopper and configured to receive waste from the hopper, and to compact the waste into bales.

2. The mobile unit of claim 1, wherein the transport vehicle is a truck having a power take-off (PTO) and at least three axles.

3. The mobile unit of claim 1, wherein the compactor has a bale door having a closed position and an open position, the bale door configured to retain the waste within the compactor during compaction and baling when closed, and to allow the waste to exit the compactor when open.

4. The mobile unit of claim 1, wherein the waste collection and handling assembly further comprises a generator that is connected to and powers the compactor.

5. The mobile unit of claim 2, wherein the loader is connected to and receives power from the PTO of the truck.

6. The mobile unit of claim 1, wherein the loader is hydraulically controlled, and the waste collection and handling assembly further comprises a hydraulic cooler configured to cool the hydraulics that control the loader.

7. The mobile unit of claim 6, wherein the waste collection and handling assembly further comprises wire mesh attached to the guard rails and extending over the top of the compactor to allow a user to stand above the compactor and view its activity.

8. The mobile unit of claim 1, wherein the waste collection and handling assembly further comprises a fluid waste tank fluidly connected to the compactor for collecting fluid waste.

9. A waste compacting and baling assembly, comprising:
a waste compactor having a hopper attached thereto, the waste compactor arranged and designed to receive waste through the hopper and compact the waste into bales;
a loader having means to collect waste and deliver it to the hopper; and
a transport vehicle attached to the waste compactor and the loader and capable of moving the waste compactor and the loader from one location to another.

10. The mobile unit of claim 9, wherein the transport vehicle is a truck having a power take-off (PTO) and at least three axles.

11. The mobile unit of claim 9, wherein the compactor has a bale door having a closed position and an open position, the bale door configured to retain the waste within the compactor during compaction and baling when closed, and to allow the waste to exit the compactor when open.

12. The mobile unit of claim 11, wherein the bale door is hydraulically controlled.

13. The mobile unit of claim 9, wherein the waste compacting and baling assembly further comprises a generator that is connected to and powers the compactor.

14. The mobile unit of claim 10, wherein the loader is connected to and receives power from the PTO of the truck.

15. The mobile unit of claim 9, wherein the loader is hydraulically controlled, and the waste compacting and baling assembly further comprises a hydraulic cooler configured to cool the hydraulics that control the loader.

16. The mobile unit of claim 15, wherein the waste compacting and baling assembly further comprises wire mesh attached to the guard rails and extending over the top of the compactor to allow a user to stand above the compactor and view its activity.

17. The mobile unit of claim 9, wherein the waste compacting and baling assembly further comprises a fluid waste tank fluidly connected to the compactor for collecting fluid waste.

18. A method compacting and baling waste using a portable waste compactor, comprising the steps of:
transporting a waste compactor with a hopper to a worksite on a vehicle;
delivering waste to the waste compactor through the hopper with a loader;
compacting and baling the waste within the waste compactor using a drive ram within the waste compactor;
expelling the baled waste out of the waste compactor.

19. The method of claim 18, further comprising tying the baled waste with wire.

20. The method of claim 18, further comprising draining fluid from the compactor into a fluid waste tank.

21. The method of claim 18, wherein the step of delivering waste to the hopper with the loader further comprises:
gripping the waste with a claw attached to the loader;
pushing the waste through the hopper into the waste compactor; and
rotating the claw as it pushes the waste through the hopper to help facilitate entry of the waste into the waste compactor.
